(19) United States
(12) Patent Application Publication
(10) Pub. No.: US 2015/0012392 A1
(43) Pub. Date: Jan. 8, 2015

(54) METHOD OF OWNERSHIP CERTIFICATION AND AUTHENTICATING COMMODITY OF VALUE PURCHASES VIA SUCH OWNERSHIP CERTIFICATION USING CURRENCY SERIAL NUMBERS

(71) Applicants: Ferdinando Silvestri, Sunny Isles Beach, FL (US); Alexandru Gheorghiu, Fort Lauderdale, FL (US)

(72) Inventors: Ferdinando Silvestri, Sunny Isles Beach, FL (US); Alexandru Gheorghiu, Fort Lauderdale, FL (US)

(21) Appl. No.: 14/322,639

(22) Filed: Jul. 2, 2014

Related U.S. Application Data
(60) Provisional application No. 61/842,410, filed on Jul. 3, 2013.

(51) Int. Cl. G06Q 30/06

(52) U.S. Cl. CPC G06Q 30/0637
USPC 705/26.82

(57) ABSTRACT

A method of certifying ownership of something, or authenticating a commodity of value via such ownership certification method, incorporates the use of a unique string of currency serial numbers. In an implementation of the method, an individual may access a merchant offering a commodity of value for sale by, for example, logging onto a website of the merchant; logging onto a mobile device application that interfaces with the merchant; telephoning the merchant; and entering a retail location associated with the merchant. The individual subsequently makes a purchase of at least one commodity of value and associates the purchase of the commodity of value with a unique serial number of a currency bill in the possession of the individual making the purchase, such that the currency bill having the associated unique serial number, when produced at a later time, functions to authenticate the purchase of the commodity of value.

### CROSS REFERENCE TO RELATED APPLICATION

This U.S. non-provisional patent application claims the benefit of U.S. provisional patent application No. 61/842,410, filed Jul. 3, 2013, which is hereby incorporated in its entirety herein by reference thereto.

### FIELD OF THE INVENTION

The present invention relates generally to systems and methods for certifying ownership of something and/or authenticating the purchase of a commodity of value, such as, for example, lottery tickets/bets, event admissions and the like. More particularly, the invention pertains to such systems and methods that incorporate the use of a unique serial number from currency such as a paper bill.

### BACKGROUND OF THE INVENTION

There is a pressing security concern associated with purchasing commodities of value online, including tangible and intangible goods and assets, such as, for example, event admissions and lottery bets. Online purchasing is a convenient method of purchasing commodities of value within the comfort of a consumer's home; however, there is a pressing security concern with online purchasing.

The process for purchasing a commodity online typically begins with selection of the commodity and online payment thereof via a credit card, debit card, bank account information, and the like. Typically, this is followed by presentation of an electronic receipt displayed on a purchaser's computer, which can be physically printed by the purchaser in order to generate a printed receipt. Next, the purchaser brings the printed receipt to a redeeming center, such as a store, an event, or lottery winnings redemption center. The purchaser then presents the printed receipt to personnel at the redeeming center in order to authenticate the purchase of the selected commodity. Finally, the commodity, i.e. the product, admission, or winnings, are granted to the purchaser.

Nevertheless, as is well known in the art, any online purchasing system can be susceptible to a security breach. For example, in the area of online purchasing of lottery tickets, there is a concern that a hacker could potentially hack into the online purchasing system of a lottery game and generate a counterfeit printed receipt for a winning ticket. Likewise, in the area of online purchasing of event tickets, there is a concern that a hacker could breach the online security system and generate a counterfeit ticket for the event. If a wrongdoer is aware of the format of the event ticket or lottery ticket and a method of reproducing it, such wrongdoer could actually generate the ticket independently without the need to hack into the online ticket purchasing system. Repeated occurrences of such security breaches could quickly undermine and destroy the credibility and viability of the targeted purchasing system. As can be seen, purchasing tickets (lottery or event tickets) online, wherein a physical receipt of sorts is required to redeem the benefit of the purchased item is susceptible to a security breach. No online system is hack-proof and if the online system is breached, a counterfeit physical receipt can be duplicated to unjustly obtain the benefit prior to the bona fide purchaser.

Moreover, there is also an inconvenience factor associated with requiring purchasers or vendors to physically print a receipt or ticket, which utilizes resources, such as paper, a printer, and ink. In this electronic age, where convenience and economies of time are a significant value, any system, apparatus and/or method that aids in reducing time and use of resources will find value.

There is also an issue with purchasing commodities of value over the telephone and in person at a vendor or store. There is a desire in this electronic age to provide authentication of such purchases without the requirement of a physical printed item, which wastes resources, time, and money.

Accordingly, there remains a need in the art for a way to provide a measure of security and authentication for purchases, including, but not limited to, lottery bets and event admissions purchased online, at a retail store, or via the telephone. Furthermore, it would be highly desirable to provide such a system and method that is not limited to purchasing commodities of value, but also for simply certifying ownership of something.

### SUMMARY OF THE INVENTION

The present invention overcomes the deficiencies of the known art and the problems that remain unsolved by providing a method of authenticating commodity of value purchases using currency serial numbers. The purchases may include, but not limited to, lottery and event admission purchases, particularly online purchases. However, the authenticating method may also be used for purchases made at a retail location or over the telephone, in order to eliminate the need to use physical tickets for authenticating such purchases. As will be apparent to those skilled in the art, while the exemplary implementations primarily deal with purchasing commodities of value, the present invention is just as easily employed for the purpose of certifying ownership of something and, accordingly, is not intended to be limited to purchasing commodities of value.

In one aspect of the present invention, a method of authenticating a purchase of a commodity of value comprises the steps of:

accessing an entity that sells at least one commodity of value;

making a purchase of the at least one commodity of value; and

associating the purchase of the at least one commodity of value with a unique serial number of a currency bill not used in making the purchase so that the currency bill having the associated unique serial number when produced at a later time authenticates the purchase of the at least one commodity of value.

In another aspect of the present invention, accessing the entity is performed by accessing a website of the entity. Further, accessing the website of the entity is performed by logging onto the website.

In another aspect of the present invention, accessing the entity is performed by logging onto a mobile device app that interfaces with the entity, telephoning the entity, or entering a retail location associated with the entity where the entity sells the at least one commodity of value.

In another aspect of the present invention, the at least one commodity of value comprises indicia explanatory of the value of the at least one commodity. Also, the at least one commodity of value is a printed item being either a lottery ticket wherein the indicia are representative of a bet placed within a lottery game or an event ticket wherein the indicia grant the right of entry to an event.

In another aspect of the present invention, associating the purchase of the at least one commodity of value with the unique serial number of the currency bill is performed by entering the unique serial number of the currency bill into a computer having a searchable storage medium. Further, entering the unique serial number of the currency bill is performed by either manually inputting the unique serial number of the currency bill into the computer or scanning an image of the currency bill showing the unique serial number into the computer.

In another aspect of the present invention, said associating is further performed by storing the unique serial number of the currency bill in the searchable storage medium of the computer, and linking the unique serial number of the currency bill to the indicia of the at least one commodity of value so that they are retrievable from the searchable storage medium for comparison with a unique serial number of a currency bill produced at the later time for authenticating the at least one commodity of value purchased.

In another aspect of the present invention, making the purchase of the at least one commodity of value is performed by entering a transaction with the entity based providing one of cash, a credit card, a debit card or a prepaid card.

In another aspect of the present invention, a method of authenticating a purchase of a lottery bet comprises the steps of:

accessing a lottery retailer by one of
logging onto a website of the lottery retailer,
logging onto a mobile device app of the lottery retailer,
telephoning the lottery retailer, and
entering a retail location associated with the lottery retailer, where the retail location sells lottery bets pertaining to a lottery game;

making a purchase of at least one lottery bet of the lottery game; and

associating the purchase of the at least one lottery bet with a unique serial number of a currency bill in the possession of a purchaser making the purchase so that the currency bill having the associated unique serial number when produced at a later time authenticates the purchase of the at least one lottery bet.

In another aspect of the present invention, a method of authenticating a purchase of an event admittance comprises the steps of:

accessing an event admissions retailer by one of
logging onto a website of the event admissions retailer,
logging onto a mobile device app of the event admissions retailer,
telephoning the event admissions retailer, and
entering a retail location associated with the event admissions retailer, where the retail location sells event admissions;

making a purchase of at least one event admittance that grants the right of entry to an event; and

associating the purchase of the at least one event admittance with a unique serial number of a currency bill in the possession of a purchaser making the purchase so that the currency bill having the associated unique serial number when produced at a later time authenticates the purchase of the at least one event admittance.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, in which:

FIG. 1 presents a flow chart illustrating an exemplary embodiment of a method of authenticating lottery bet purchases made online, the method constituting one aspect of the present invention;

FIG. 2 presents a flow chart illustrating an exemplary embodiment of a method of authenticating lottery bet purchases made over the telephone, the method constituting another aspect of the present invention;

FIG. 3 presents a flow chart illustrating an exemplary embodiment of a method of authenticating lottery bet purchases made at a retail location, the method constituting still another aspect of the present invention;

FIG. 4 presents a flow chart illustrating an exemplary embodiment of a method of authenticating event admittance purchases made online, the method constituting yet another aspect of the present invention;

FIG. 5 presents a flow chart illustrating an exemplary embodiment of a method of authenticating event admittance purchases made over the telephone, the method constituting a further aspect of the present invention;

FIG. 6 presents a flow chart illustrating in general a method of authenticating a commodity of value purchase, the flow chart encompassing the various exemplary embodiments of the authenticating method shown in FIGS. 1-5;

FIG. 7 presents a flow chart illustrating, in a detailed exemplary embodiment, the final step of the commodity of value purchase authenticating method presented by the flow chart of FIG. 6, such step being associating the commodity of value purchase with unique serial number of a currency bill in possession of the user making the purchase; and

FIG. 8 presents a flow chart for an exemplary implementation of the method for use in connection with lotteries, detailing the steps of creating both paying and playing accounts.

Like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

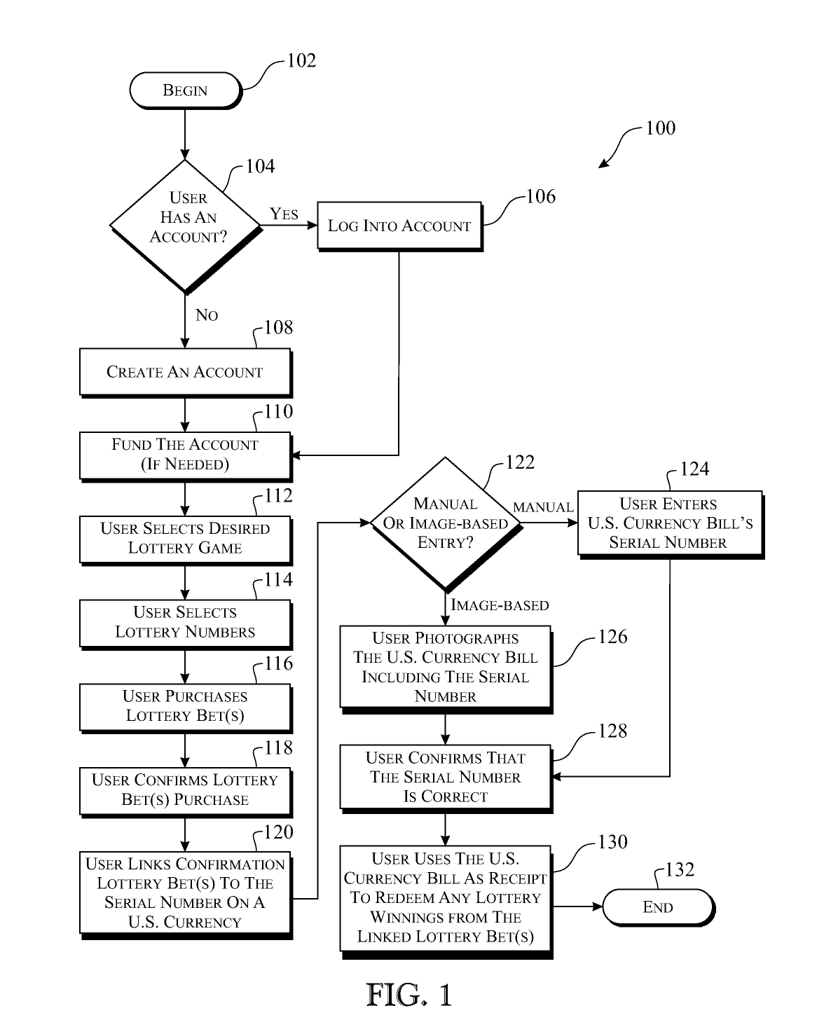

Additionally, although FIGS. 1-6 show a specific order of executing functional logic blocks, the order of executing the blocks may be changed relative to the order shown. Also, two or more blocks shown in succession may be executed concurrently or with partial concurrence. Certain blocks may also be omitted for the sake of brevity. And some blocks may be merely exemplary steps in an exemplary implementation, but are not required in order to be in accordance with the present invention.

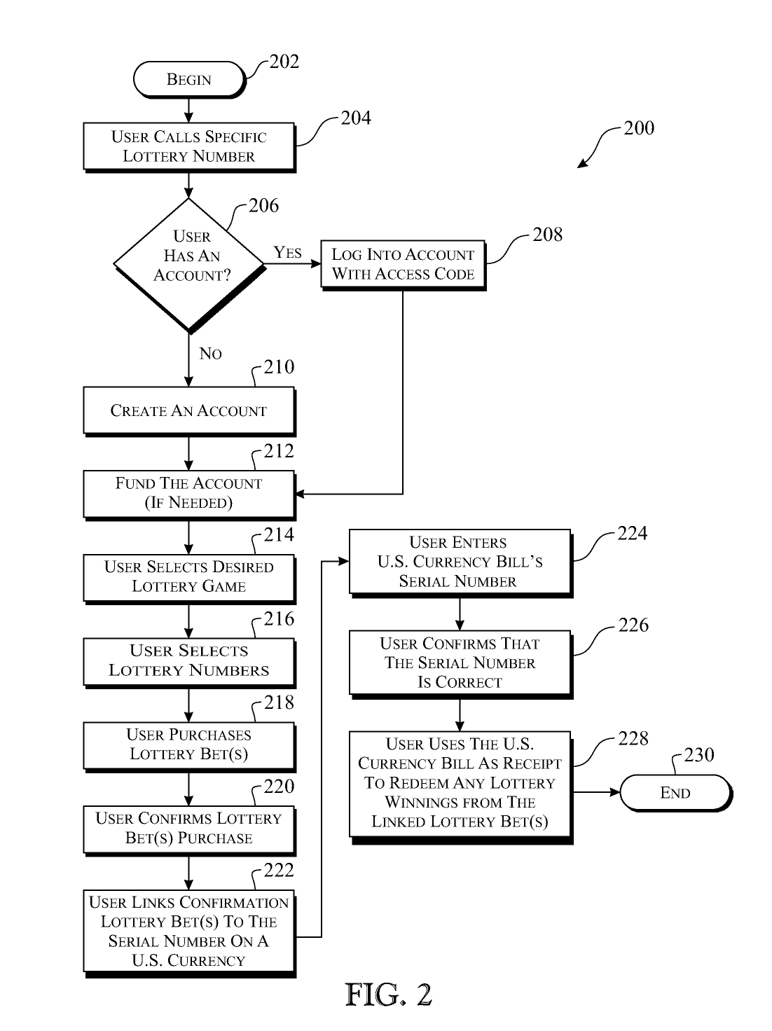

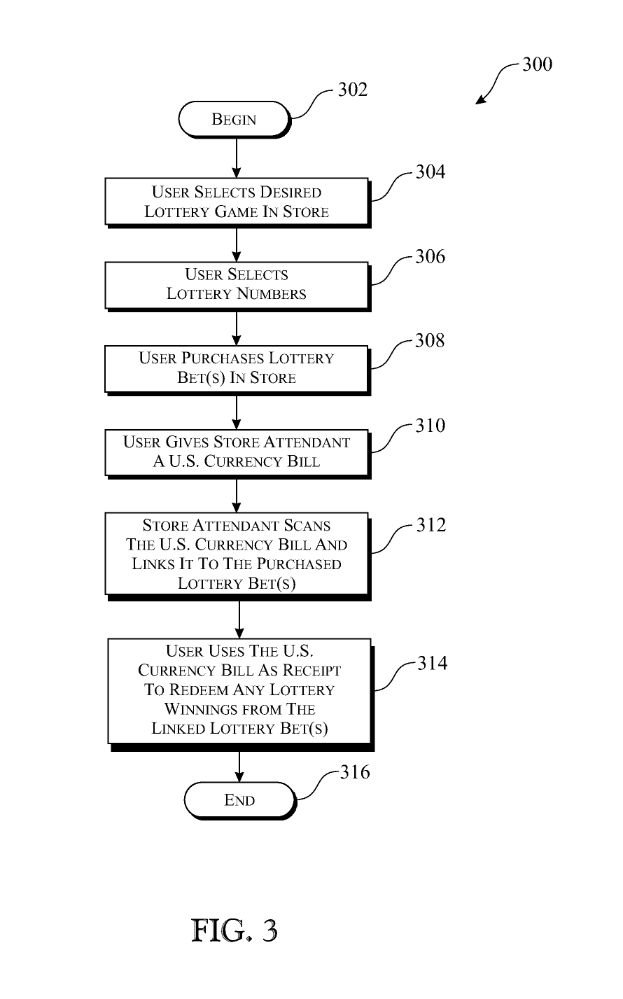

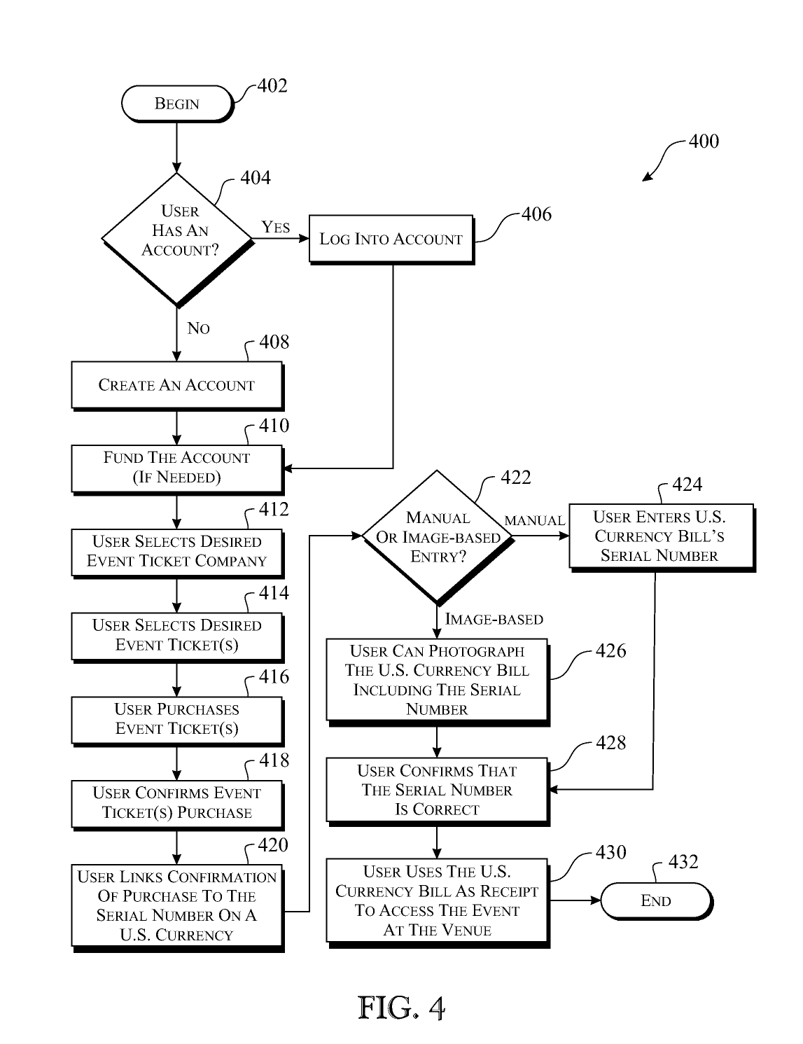

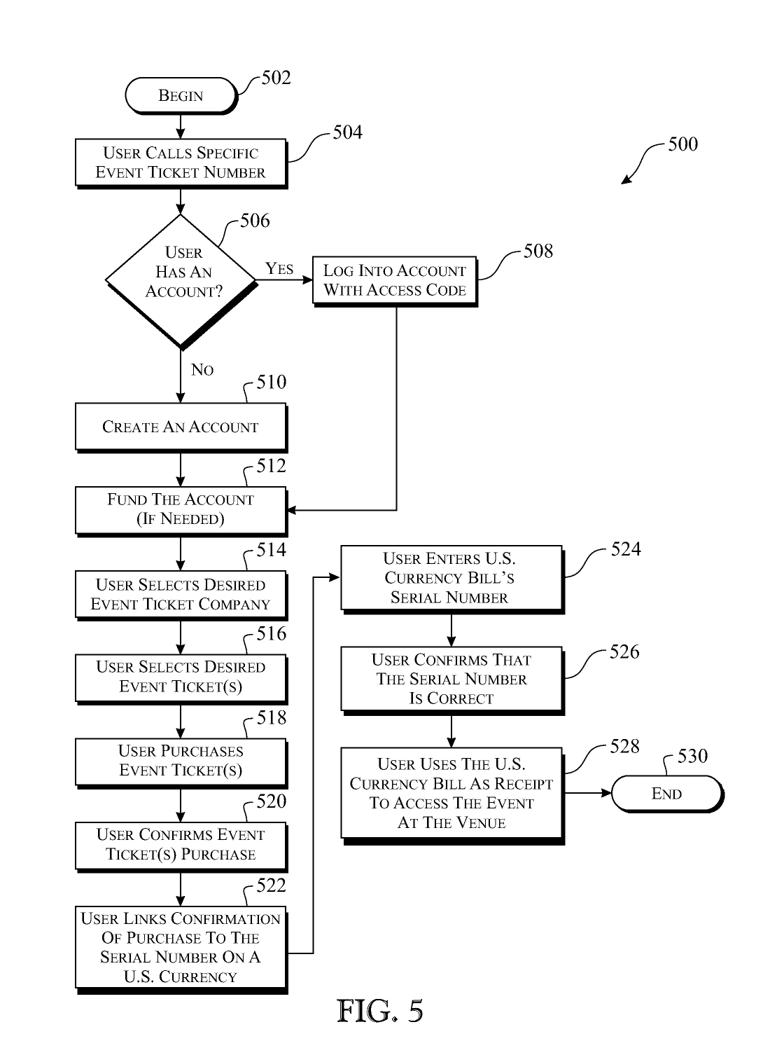

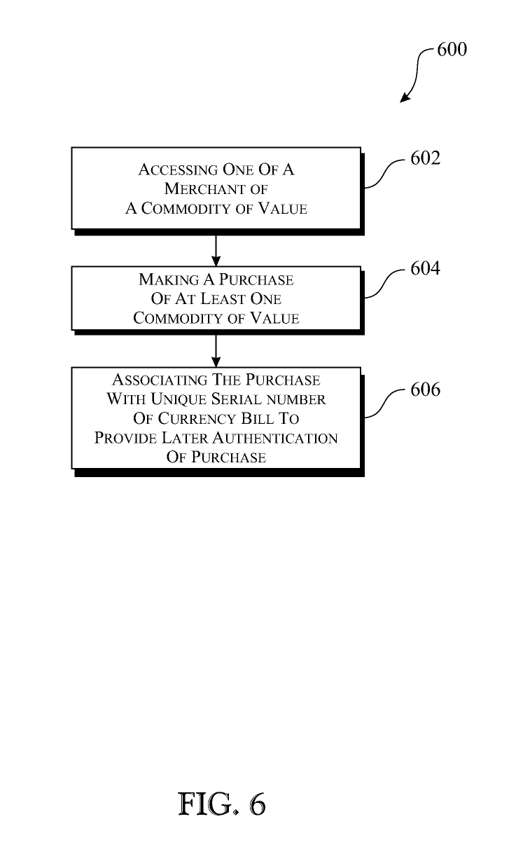

Referring now to FIGS. 1-5, flow charts are presented illustrating respective exemplary embodiments of a method of authenticating lottery bet and event admittance purchases as examples of commodity of value purchases, which constitute various aspects of the present invention. Each of these respective exemplary embodiments of the authenticating method relies on the uniqueness of the serial number of each currency bill, for example a U.S. currency bill, and the physicality of such paper currency to enhance security in terms of authentication of the purchase of a lottery bet that is a winning bet or an event admittance granting the right of entry to the event. The authenticating method is applicable to a lottery bet purchase made either online via the Internet (by accessing a website or mobile device app), as shown in FIG. 1, over a telephone, as shown in FIG. 2, or at a retail location, as shown in FIG. 3. The authenticating method is also applicable to an event admittance purchase made either online (via a website or mobile device app), as shown in FIG. 4, or over a telephone, as shown in FIG. 5. In fact, the authentication method can be applicable to a purchase of any commodity of value made online, over a telephone, or at a retail location, as shown in FIG. 6 and described in detail in the associated section below.

Referring to FIG. 1, a flow chart, generally designated 100, is presented illustrating the respective exemplary embodiment of the method of authenticating a lottery bet purchase made by a user online, for example over the Internet via a website or a mobile device app. The authenticating method begins, as per symbol 102, on the Internet via a website or a mobile device app of a lottery sponsoring entity and then proceeds with a determination of whether the user has an account, as per symbol 104, allowing the user to access the lottery sponsoring entity. If the user has an account (“Yes”) the user logs into the account, as per symbol 106. If the user doesn't have an account (“No”) the user creates a new account, as per symbol 108.

After logging into the preexisting account, as per symbol 106, or creating the new account, as per symbol 108, the user must fund the account, as per symbol 110, if a new account has been created or the preexisting account is found with insufficient funds. After providing the necessary level of funding, the user in sequence does the following: first, selects the desired lottery game, as per symbol 112; second, selects the lottery numbers or indicia, as per symbol 114; third, purchases the lottery bet(s), as per symbol 116; and, fourth, confirms the lottery bet(s) purchase, as per symbol 118.

Following thereafter, as per symbol 120, the user links or associates confirmation of the lottery bet(s) to the unique serial number on a currency bill (for example, U.S. currency) selecting, as per symbol 122, to use one of two methods or ways of providing a record of the unique serial number: either by entering the U.S. currency bill's unique serial number (“manual entry”), as per symbol 124, or by photographing the U.S. currency bill including the unique serial number, as per symbol 126 (“image-based entry”). After providing the record, as per symbol 124 or 126, the user confirms that the recorded unique serial number is correct (and then logs off the website or mobile device app of the lottery sponsoring entity), as per symbol 128. At a later time, as per symbol 130, the user will use the U.S. currency bill as a receipt to authenticate and redeem any lottery winnings from the linked or associated lottery bet(s) or ticket(s). Finally, the authenticating method reaches the end, as per symbol 132.

Referring to FIG. 2, a flow chart, generally designated 200, is presented illustrating the respective exemplary embodiment of the method of authenticating a lottery bet purchase made by a user over a telephone. The authenticating method begins, as per symbol 202, with the user calling the telephone number of the lottery sponsoring entity, as per symbol 204, and then proceeds with a determination of whether the user has an account, as per symbol 206, allowing the user to access the lottery sponsoring entity. If the user has an account (“Yes”) the user logs into the account, as per symbol 208. If the user doesn't have an account (“No”) the user creates a new account, as per symbol 210.

After logging into the preexisting account, as per symbol 208, or creating the new account, as per symbol 210, the user must fund the account, as per symbol 212, if a new account has been created or the preexisting account is found with insufficient funds. After providing the necessary level of funding, the user in sequence does the following: first, selects the desired lottery game, as per symbol 214; second, selects the lottery numbers or indicia, as per symbol 216; third, purchases the lottery bet(s), as per symbol 218; and, fourth, confirms the lottery bet(s) purchase, as per symbol 220.

Following thereafter, as per symbol 222, the user links or associates confirmation of the lottery bet(s) to the unique serial number on a currency bill (for example, U.S. currency). Next, the user enters the U.S. currency bill's unique serial number, as per symbol 224. Lastly, the user confirms that the entered unique serial number is correct (and then terminates the telephone call to the lottery sponsoring entity), as per symbol 226. At a later time, as per symbol 228, the user will use the U.S. currency bill as a receipt to authenticate and redeem any lottery winnings from the linked or associated lottery bet(s). Finally, the authenticating method reaches the end, as per symbol 230.

Referring to FIG. 3, a flow chart, generally designated 300, is presented illustrating the respective exemplary embodiment of the method of authenticating a lottery bet purchase made at a retail location or store. The authenticating method begins, as per symbol 302, with a user entering the store. Next, the user in sequence does the following: first, selects the desired lottery game in the store, as per symbol 304; second, selects the lottery numbers or indicia, as per symbol 306; third, purchases the lottery bet(s), as per symbol 308; and, fourth, gives the store attendant a U.S. currency bill, as per symbol 310. Then, the store attendant scans the U.S. currency bill including its unique serial number and links or associates it to the purchased lottery bet(s), as per symbol 312, thereafter returning the scanned currency bill to the user. At a later time, as per symbol 314, the user will use the U.S. currency bill as a receipt to authenticate and redeem any lottery winnings from the linked or associated lottery bet(s). Finally, the authenticating method reaches the end, as per symbol 316.

Referring to FIG. 4, a flow chart, generally designated 400, is presented illustrating the respective exemplary embodiment of the method of authenticating an event admittance or event ticket purchase made by a user online, for example over the Internet via a website or a mobile device app. It is understood that the method may include purchase of an event ticket or merely purchase of admission to the event, wherein presentation of the U.S. currency bill authenticates purchase of admission and grants the user right of entry without a separate ticket, as in the case of a lottery bet purchase. Nevertheless, most event tickets have useful information such as a seating number, thus the U.S. currency bill may authenticate purchase of an event ticket as well. In the exemplary embodiment illustrated in FIG. 4, an event ticket is purchased.

The authenticating method begins, as per symbol 402, on the Internet via website or a mobile device app of an event sponsoring entity and then proceeds with a determination of whether the user has an account, as per symbol 404, allowing the user to access the event sponsoring entity. If the user has an account (“Yes”) the user logs into the account, as per symbol 406. If the user doesn't have an account (“No”) the user creates a new account, as per symbol 408.

After logging into the preexisting account, as per symbol 406, or creating the new account, as per symbol 408, the user must fund the account, as per symbol 410, if a new account has been created or the preexisting account is found with insufficient funds. After providing the necessary level of funding, the user in sequence does the following: first, selects the desired event ticket company, as per symbol 412; second, selects the desired event ticket(s), as per symbol 414; third, purchases the event ticket(s), as per symbol 416; and, fourth, confirms the event ticket(s) purchase, as per symbol 418.

Following thereafter, as per symbol 420, the user links or associates confirmation of the event ticket(s) to the unique serial number on a currency bill (for example, U.S. currency) selecting, as per symbol 422, to use one of two methods or ways of providing a record of the unique serial number: either by entering the U.S. currency bill's unique serial number, as per symbol 424, or by photographing the U.S. currency bill including the unique serial number, as per symbol 426. After providing the record, as per symbol 424 or 426, the user confirms that the recorded unique serial number is correct (and then logs off the website or mobile device app of the event sponsoring entity), as per symbol 428. At a later time, as per symbol 430, the user will use the U.S. currency bill as a receipt to authenticate the associated event ticket(s) and gain access or entry to the event at the venue. Finally, the authenticating method reaches the end, as per symbol 432.

Referring to FIG. 5, a flow chart, generally designated 500, is presented illustrating the respective exemplary embodiment of the method of authenticating an event ticket purchase made by a user over a telephone. The authenticating method begins, as per symbol 502, with the user calling the telephone number of the event sponsoring entity, as per symbol 504, and then proceeds with a determination of whether the user has an account, as per symbol 506, allowing the user to access the event sponsoring entity. If the user has an account (“Yes”) the user logs into the account, as per symbol 508. If the user doesn't have an account (“No”) the user creates a new account, as per symbol 510.

After logging into the preexisting account, as per symbol 508, or creating the new account, as per symbol 510, the user must fund the account, as per symbol 512, if a new account has been created or the preexisting account is found with insufficient funds. After providing the necessary level of funding, the user in sequence does the following: first, selects the desired event ticket company, as per symbol 514; second, selects the desired event ticket(s), as per symbol 516; third, purchases the event ticket(s), as per symbol 518; and, fourth, confirms the event ticket(s) purchase, as per symbol 520.

Following thereafter, as per symbol 522, the user links or associates confirmation of the event ticket(s) to the unique serial number on a currency bill (for example, U.S. currency). Next, the user enters the U.S. currency bill's unique serial number, as per symbol 524. Lastly, the user confirms that the entered unique serial number is correct (and then terminates the telephone call to the event sponsoring entity), as per symbol 526. At a later time, as per symbol 528, the user will use the U.S. currency bill as a receipt to authenticate the associated event ticket(s) and gain access or entry to the event at the venue. Finally, the authenticating method reaches the end, as per symbol 530.

Referring to FIG. 6, a flow chart, generally designated 600, is presented illustrating in general a method of authenticating a purchase of a commodity of value that encompasses the various exemplary embodiments of the authenticating method shown in FIGS. 1-5. The method of authenticating a purchase of a commodity of value, as seen in FIG. 6, includes: as per symbol 602, accessing one of an entity, such as a merchant, of a commodity of value, such as, by a user doing one of logging onto a website or mobile device app of the respective merchant, telephoning the respective merchant, or entering a retail location of the respective merchant, where corresponding commodities of value are on sale; as per symbol 604, the user making a purchase of at least one commodity of value; and, as per symbol 606, associating the purchase of the commodity of value with a unique serial number of a currency bill in the possession of the user making the purchase so that the currency bill with the associated unique serial number when produced at a later time authenticates the purchase of the commodity of value. It is understood that the commodity of value can be any tangible or intangible item of value, such as lottery bets and event admission purchases, but also including, although not limited to other goods, services, and the like. The purchase is performed by the user entering a transaction with the entity based on providing one of cash, a credit card, a debit card, or a prepaid card.

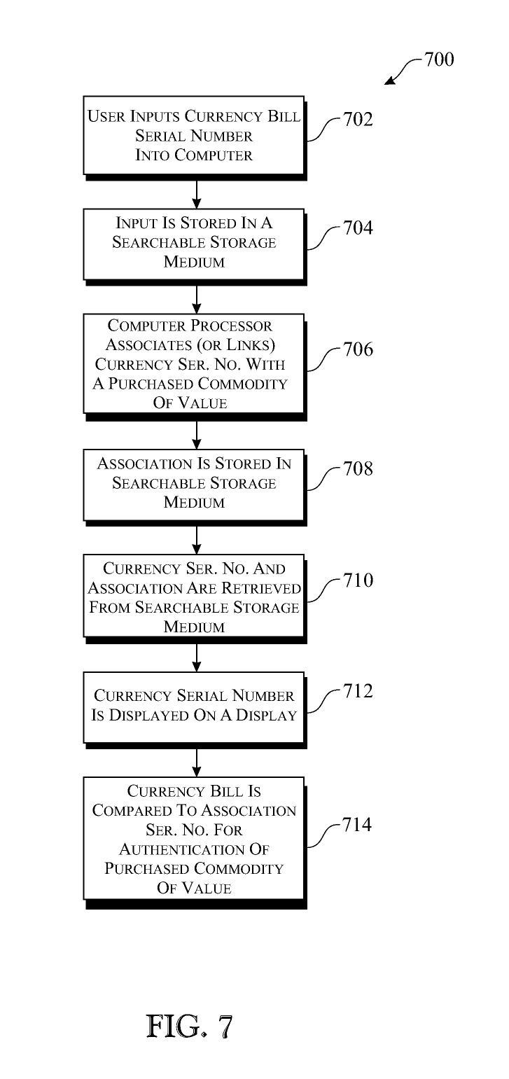

Associating the purchase of the commodity of value with a unique serial number of a currency bill in the possession of the user making the purchase, as per symbol 606 of FIG. 6, may be accomplished, as illustrated in the flowchart presented in FIG. 7 and generally designated as 700, by using a computer having a searchable storage medium, such as a memory, a processor, a display and preferably a network interface card for connecting with a large area network, such as the Internet. As per symbol 702, a user inputs a unique currency serial number, whether manual or image-based, via the Internet, over the telephone, or at a retail location into the computer. It is understood that any manner of allowing a user to input a numeric or alphanumeric code into a computer, which may or may not be remotely located, can be used. For example, the user can scan or photograph an image of a bill showing the unique currency serial number into a user-accessible computing device, such as, for example, a personal computer, computer tablet, mobile telephone, or other handheld device. The image is then transmitted via the Internet to the computer used to store and associate currency serial numbers for the merchant. In a second example, the user can input the currency serial number manually using a user input interface, such as a keyboard or touchscreen, of a user-accessible computing device. In yet another example, the user may telephone keys to input the currency serial number over the telephone. In yet another example, the user may verbally communicate the currency serial number to an operator over the telephone, which operator then inputs the currency serial number into an operator-accessible computer.

After the currency serial number is entered, the input or entry is stored in the storage medium, as per symbol 704. The processor associates the currency serial number entry with a purchased commodity of value, as per symbol 706, and stores the association in the storage medium, as per symbol 708. Subsequently, when the user desires to redeem the purchased commodity of value (e.g. lottery winnings or event admission) the currency serial number entry and commodity of value association is retrieved from the storage medium, as per symbol 710, and displayed on the display, as per symbol 712. An agent of the merchant providing the redeemed purchased commodity of value, such as, for example, a retail store clerk or an attendant at an event, can then compare the retrieved associated currency serial number with the physically presented currency bill in order to authenticate the purchase, as per symbol 714.

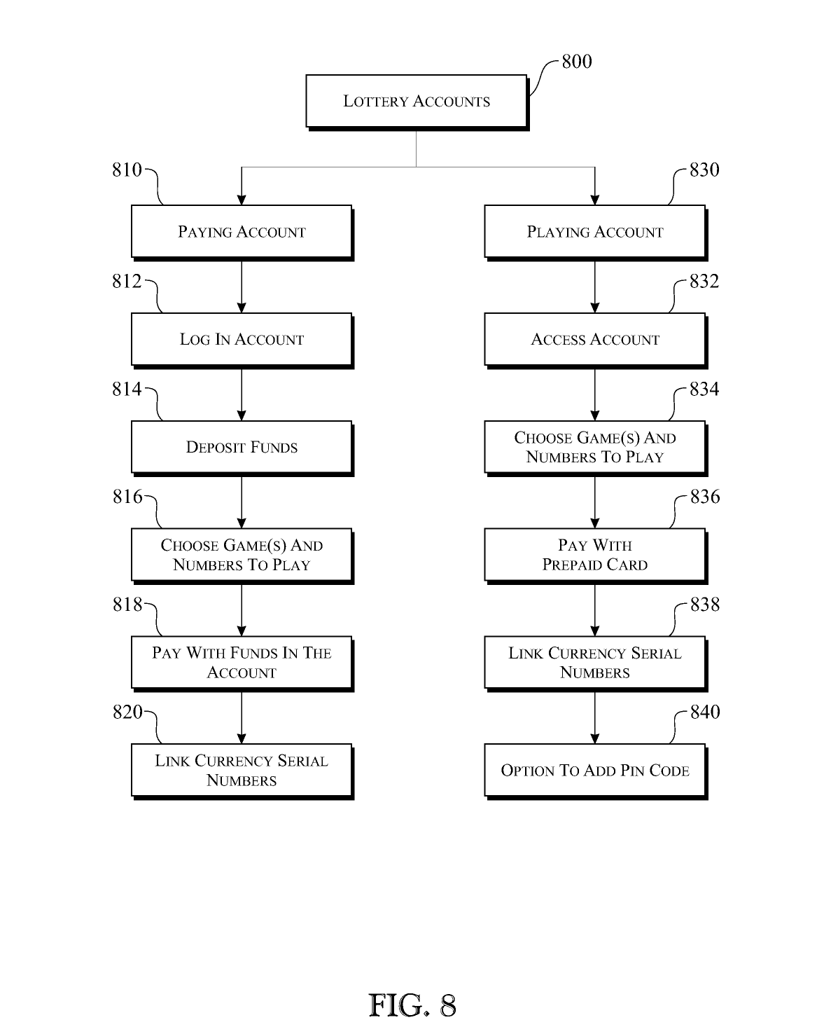

Referring briefly to FIG. 8, in the exemplary implementation wherein the system and method of the present invention are utilized in connection with the purchase and authentication of lottery games, lottery accounts can be created and utilized, as shown generally by reference numeral 800, by variable methods such as those depicted by steps 810-820 versus those depicted by steps 830-840.

In the first method, a Paying Account is initially created at step 810. Subsequently, a user/player can go through the serial steps of: logging into the account 812, initially funding or adding funds to an existing account 814, selecting particular games and respective game numbers to play 816, paying for the games 818 using the funds provided in step 814 and, finally, linking one or more currency serial numbers from player held currency to the selected games.

In the second method, a Playing Account is initially created at step 830. In this method, the Playing Account is created in such a manner that the player is able to remain anonymous. After being anonymously created at step 830, the user is able to selectively access the account anonymously 832, choose particular games and corresponding game numbers to play 834, pay or fund the account using a prepaid lottery card 836, which offers ability for the player to anonymously fund such play, link one or more currency serial numbers from player held currency to the selected games, and then optionally add a Personal Identification Number (PIN) code as an added security measure while still supporting full anonymity of the player.

Therefore, as will be apparent to those skilled in the art, the systems and methods of the present invention have the benefit of being able to be employed in various modes: one where the player identity is known, and one where the player is able to maintain complete anonymity.

In summary, the method of the present invention can be used for authenticating via currency serial numbers transactions made via phone, Internet, in retail locations, and the like, and more particularly for validation of a multitude of goods and services, including, but not limited to, multiple games, bets, betting competitions, lotto, lotteries, similar games and events in general. The concept underlying the method of the present invention relies on or takes advantage of the fact that a currency bill typically, and a U.S. currency bill always, has a unique serial number so that a selected currency bill thus provides a unique physical item that can be possessed by a user and presented in order to redeem winnings (other than a physical ticket purchased at a retail location). The uniqueness of the serial number and the physicality of paper currency can be utilized to provide additional security for online purchases. The method allows users to purchase any lottery bet(s) online, via a website or mobile device app, from any vendor. After the user has selected his or her desired lottery vendor and game, the user can associate a confirmation lottery bet to a serial number on the currency bill. Once the lottery bet is linked to the serial number, the user retains and utilizes the currency bill associated with the lottery bet in order to redeem any lottery winnings gained from the bet. The method is structured to work with a variety of purchasing methods. It can also be used to authenticate other online purchases, such as event tickets.

It will be understood that the use of the unique serial number on a currency bill to authenticate a commodity of value purchase provides a basic or primary mode of authentication. The unique serial number of the currency bill possessed by the user provides a “what only I have” form of authentication. One or more supplemental modes of authentication may be employed as follows. One example of a supplemental mode of authentication that may be used is a phrase or a numerical code (traditionally referred to as a personal identification number or “PIN”) which provides a “what I know” form of authentication. With the incorporation of

Another example of a supplemental mode of authentication that may be used is a given biometric of the specific purchaser possessing the currency bill which provides a “what I am” form of authentication. There are many types of biometrics that can be used, for example, a fingerprint, voice print, retina scan, palm scan, face recognition and the like. The addition of any of these secondary modes of authentication means that the currency bill with the unique serial number is assigned to a specific purchaser (identified or anonymous) and if the currency bill is lost by or stolen from that specific purchaser it could not be used by the finder or thief for the purpose intended herein.

The above-described embodiments are merely exemplary illustrations of implementations set forth for a clear understanding of the principles of the invention. Many variations, combinations, modifications or equivalents may be substituted for elements thereof without departing from the scope of the invention. Therefore, it is intended that the invention not be limited to the particular embodiments disclosed as the best mode contemplated for carrying out this invention, but that the invention will include all the embodiments falling within the scope of the appended claims. For example, although the system and method have been primarily described in connection with “purchasing commodities of value,” it will be readily apparent to those skilled in the art that the system and method is adaptable for use merely certifying ownership of something. For instance, the currency serial number could function to certify ownership of—and thereby claim—something not necessarily purchased. As an example, most modern casinos employ slot machines that eject a player currency balance ticket having a barcode or the like printed thereon, which displays a currency balance where the player has decided to stop playing even though they have a remaining value balance. For instance, if a slot machine player decides to get up even though they have a $75.00 credit remaining the player depresses the “Print Ticket” button, collects the ejected ticket, and then is able to present the ticket to a cashier to exchange it for $75.00 in actual currency. In this case, if we replace the ticket with a currency serial number, then the currency serial number is not being used to “purchase a commodity of value” per se; instead, the player is using the serial number as a receipt to certify ownership of something that has not been “purchased.”

What is claimed is:

1. A method of authenticating a purchase of a commodity of value, comprising steps of:
accessing an entity that sells at least one commodity of value;
making a purchase of the at least one commodity of value; and
associating the purchase of the at least one commodity of value with a unique serial number of a currency bill not used in making the purchase so that the currency bill having the associated unique serial number when produced at a later time authenticates the purchase of the at least one commodity of value.

2. The method of claim 1 further comprising also associating the purchase of the at least one commodity of value with one of a phrase, numerical code, and biometric of the purchaser.

3. The method of claim 1 wherein said accessing the entity is performed by accessing a website of the entity.

4. The method of claim 3 wherein said accessing the website of the entity is performed by logging onto the website.

5. The method of claim 1 wherein said accessing the entity is performed by logging onto a mobile device app that interfaces with the entity.

6. The method of claim 1 wherein said accessing the entity is performed by telephoning the entity.

7. The method of claim 1 wherein said accessing the entity is performed by entering a retail location associated with the entity where the entity sells the at least one commodity of value.

8. The method of claim 1 wherein the at least one commodity of value comprises indicia explanatory of the value of the at least one commodity.

9. The method of claim 8 wherein the at least one commodity of value is a lottery ticket wherein the indicia are representative of a bet placed within a lottery game.

10. The method of claim 8 wherein the at least one commodity of value is an event ticket wherein the indicia grant the right of entry to an event.

11. The method of claim 8 wherein the at least one commodity of value is a printed item of value containing the indicia.

12. The method of claim 11 wherein the printed item of value is a lottery ticket wherein the indicia are representative of a bet placed within a lottery game.

13. The method of claim 11 wherein the printed item of value is an event ticket wherein the indicia grant the right of entry to an event.

14. The method of claim 8 wherein said associating the purchase of the at least one commodity of value with the unique serial number of the currency bill is performed by entering the unique serial number of the currency bill into a computer having a searchable storage medium.

15. The method of claim 14 wherein said entering the unique serial number of the currency bill is performed by one of:
manually inputting the unique serial number of the currency bill into the computer; and
scanning an image of the currency bill showing the unique serial number into the computer.

16. The method of claim 14 wherein said associating is further performed by storing the unique serial number of the currency bill in the searchable storage medium of the computer.

17. The method of claim 16 wherein said associating is further performed by linking the unique serial number of the currency bill to the indicia of the at least one commodity of value so that they are retrievable from the searchable storage medium for comparison with a unique serial number of a currency bill produced at the later time for authenticating the at least one commodity of value purchased.

18. The method of claim 1 wherein said making the purchase of the at least one commodity of value is performed by entering a transaction with the entity based on providing one of cash, a credit card, a debit card, and a prepaid card.

19. A method of authenticating a purchase of a lottery bet, comprising the steps of:
accessing a lottery retailer by one of
logging onto a website of the lottery retailer,
logging onto a mobile device app of the lottery retailer,
telephoning the lottery retailer, and
entering a retail location associated with the lottery retailer, where the retail location sells lottery bets pertaining to a lottery game;
making a purchase of at least one lottery bet of the lottery game; and
associating the purchase of the at least one lottery bet with a unique serial number of a currency bill in the possession of a purchaser making the purchase so that the currency bill having the associated unique serial number when produced at a later time authenticates the purchase of the at least one lottery bet.

20. A method of authenticating a purchase of an event admittance, comprising the steps of:
accessing an event admissions retailer by one of
logging onto a website of the event admissions retailer,
logging onto a mobile device app of the event admission retailer,
telephoning the event admission retailer, and
entering a retail location associated with the event admission retailer, where the retail location sell event admissions;
making a purchase of at least one event admittance that grants the right of entry to an event; and
associating the purchase of the at least one event admittance with a unique serial number of a currency bill in the possession of a purchaser making the purchase so that the currency bill having the associated unique serial number when produced at a later time authenticates the purchase of the at least one event admittance.
